(19) United States
(12) Patent Application Publication
(10) Pub. No.: US 2015/0161852 A1
(43) Pub. Date: Jun. 11, 2015

(54) WAGERING GAME WITH PLAYER-CONTRIBUTED REELS

(71) Applicant: WMS Gaming Inc., Waukegan, IL (US)

(72) Inventors: Richard B. Robbins, Glenview, IL (US); Andrew C. Guinn, Chicago, IL (US); William Klein, Chicago, IL (US); Daniel P. Louie, Chicago, IL (US); Aaron John Schurman, Cedar Falls, IA (US); Bryan Vandaele, Cedar Falls, IA (US); Jamie W. Vann, Chicago, IL (US)

(73) Assignee: WMS Gaming Inc., Waukegan, IL (US)

(21) Appl. No.: 14/097,869

(22) Filed: Dec. 5, 2013

(51) Int. Cl. G07F 17/34

(52) U.S. Cl. CPC G07F 17/34

(57) ABSTRACT

In a gaming system, a first player and one or more second player(s) contribute respective player reels. At least one game outcome is determined from an array of symbols randomly generated from the combination of the player reels. The at least one game outcome is shared by all players and used to determine awards for all players. The first player may subsequently join one or more third player(s) to determine new game outcomes from a new combination of player reels.

In another gaming system, players select a combination of player reels from a pool of player reels to compete against each other. At least one game outcome is determined for each player from an array of symbols randomly generated from the player's selected subset of player reels. The players are ranked according to the game outcomes for the players, and awards are determined for the players according to the ranking.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming apparatus and methods and, more particularly, to wagering games that determine outcomes based on a combination of player reels that are contributed by a plurality of players.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

### SUMMARY OF THE INVENTION

According to one aspect of the present invention, a gaming system comprises one or more input devices; one or more display devices; and game-logic circuitry. The game-logic circuitry comprises one or more central processing units and one or more memory devices. The one or more memory devices stores instructions that, when executed by the one or more central processing units, cause the game-logic circuitry to: define at least one first player reel; associate the at least one first player reel with a first player; combine the at least one first player reel with one or more second player reels associated with one or more second players, the at least one first player reel and the one or more second player reels each including a respective set of symbols; determine at least one game outcome from an array of symbols randomly generated from the combination of the at least one first player reel and the one or more second player reels; display, on at least one of the display devices, a game screen presenting the at least one game outcome; and determine awards for the first player and the one or more second players based on the at least one game outcome. In some embodiments, in response to receiving a request from the first player via at least one of the input devices, the instructions further cause the game-logic circuitry to: combine the at least one first player reel with one or more third player reels associated with one or more third players, the one or more third player reels each including a respective set of symbols; determine at least one new game outcome from an array of symbols randomly generated from the combination of the at least one first player reel and the one or more third player reels; display, on at least one of the display devices, a new game screen presenting the at least one new game outcome; and determine awards based on the at least one new game outcome.

According to one aspect of the present invention, a gaming system comprises one or more input devices; one or more display devices; and game-logic circuitry. The game-logic circuitry comprises one or more central processing units and one or more memory devices. The one or more memory devices stores instructions that, when executed by the one or more central processing units, cause the game-logic circuitry to: define a plurality of player reels, each player reel including a respective set of symbols; receive from each of a plurality of players, via at least one of the input devices, a respective selection of a subset of the player reels; associate each of the plurality of players with the player's respective subset of player reels; determine at least one game outcome for each of the plurality of players, the at least one game outcome being determined from an array of symbols randomly generated from the player's respective subset of player reels; display, on at least one of the display devices, the at least one game outcome for each of the plurality of players; rank the players according to the game outcomes for the plurality of players; and provide awards to the players according to the ranking of the players.

According to another aspect of the invention, a computer-implemented method in a gaming system comprises: defining at least one first player reel; associating the at least one first player reel with a first player; combining the at least one first player reel with one or more second player reels associated with one or more second players, the at least one first player reel and the one or more second player reels each including a respective set of symbols; determining at least one game outcome from an array of symbols randomly generated from the combination of the at least one first player reel and the one or more second player reels; displaying a game screen presenting the at least one game outcome; determining awards based on the at least one game outcome to the first player and the one or more second players; and displaying the awards on at least one of the display devices. In some embodiments, the method further comprises: receiving a request from the first player via at least one of the input devices; in response to receiving the request, combining the at least one first player reel with one or more third player reels associated with one or more third players, the one or more third player reels each including a respective set of symbols; determining at least one new game outcome from an array of symbols randomly generated from the combination of the at least one first player reel and the one or more third player reels; displaying, on at least one of the display devices, a new game screen presenting the at least one new game outcome; determining awards based on the at least one new game outcome to the first player and the one or more third players; and displaying the awards on at least one of the display devices.

According to another aspect of the invention, a computer-implemented method in a gaming system comprises: defining a plurality of player reels, each player reel including a respective set of symbols; receiving from each of a plurality of players, via at least one of the input devices, a respective selection of a subset of the player reels; associating each of the plurality of players with the player's respective subset of player reels; determining at least one game outcome for each of the plurality of players, the at least one game outcome being determined from an array of symbols randomly generated from the player's respective subset of player reels; displaying, on at least one of the display devices, the at least one game outcome for each of the plurality of players; ranking the players according to the game outcomes for the plurality of players; and providing awards to the players according to the ranking of the players.

According to yet another aspect of the invention, computer readable storage media is encoded with instructions for directing a gaming system to perform the above methods.

According to still another aspect of the invention, the above gaming system is incorporated into a single, free-standing gaming terminal.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a schematic view of a gaming system according to an embodiment of the present invention.

FIG. 3 is an image of an exemplary basic-game screen of a wagering game displayed on a gaming machine, according to an embodiment of the present invention.

FIG. 4 is an image of an example game screen of a communal wagering game that determines an outcome based on a combination of player reels that are contributed by a plurality of players, according to aspects of the present invention.

FIG. 5 is an image of an example selection screen that allows a player to join a new group of players in a communal wagering game, according to aspects of the present invention.

FIG. 6 is an image of another example selection screen that allows a player to join a new group of players in a communal wagering game, according to aspects of the present invention.

FIG. 7 is an image of an example account screen presenting player reels associated with an account for a player of a communal wagering game, according to aspects of the present invention.

FIG. 8 is an image of another example account screen presenting player reels associated with an account for a player of a communal wagering game, according to aspects of the present invention.

FIG. 9 is an image of an example draft screen presenting player reels that can be drafted and collected for a communal wagering game, according to aspects of the present invention.

FIG. 10 is an image of another example game screen that allows a player to combine player reels for competition against other players, according to aspects of the present invention.

FIG. 11 is an image of a query screen that prompts a player after a player reel has expired, according to aspects of the present invention.

FIG. 12 is an example approach for conducting a communal wagering game, according to aspects of the present invention.

FIG. 13 is another example approach for conducting a communal wagering game, according to aspects of the present invention.

FIG. 14A is an image of an example game screen of a communal wagering game that includes a special symbol on a player reel relating to a secondary game, according to aspects of the present invention.

FIG. 14B is an image of an example game screen of the secondary game associated with the special symbol on the player reel of FIG. 14A, according to aspects of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

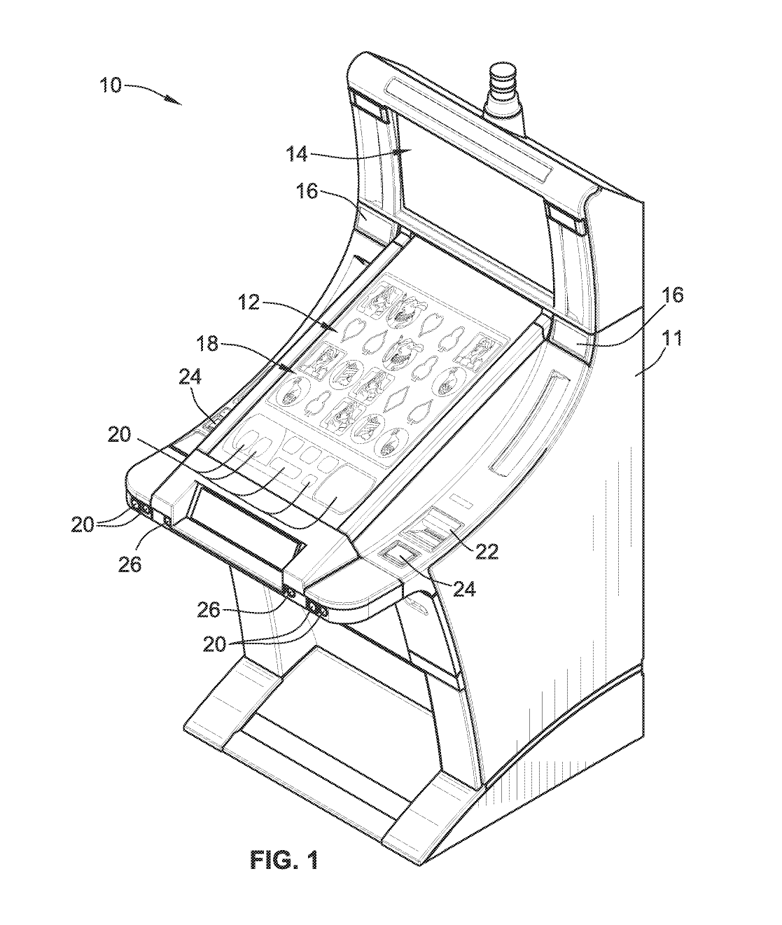

Referring to FIG. 1, there is shown a gaming machine 10 similar to those used in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in conducting wagering games, or may include non-dedicated devices, such as mobile phones, personal digital assistants, personal computers, etc. Exemplary types of gaming machines are disclosed in U.S. Pat. No. 6,517,433 and Patent Application Publication Nos. US2010/0069160 and US2010/0234099, which are incorporated herein by reference in their entireties.

The gaming machine 10 illustrated in FIG. 1 comprises a cabinet 11 that may house various input devices, output devices, and input/output devices. By way of example, the gaming machine 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

Input devices, such as the touch screen 18, buttons 20, a mouse, a joystick, a gesture-sensing device, a voice-recognition device, and a virtual-input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a game-logic circuitry for processing. The electronic data signals are selected from a group consisting essentially of an electrical current, an electrical voltage, an electrical charge, an optical signal, an optical element, a magnetic signal, and a magnetic element.

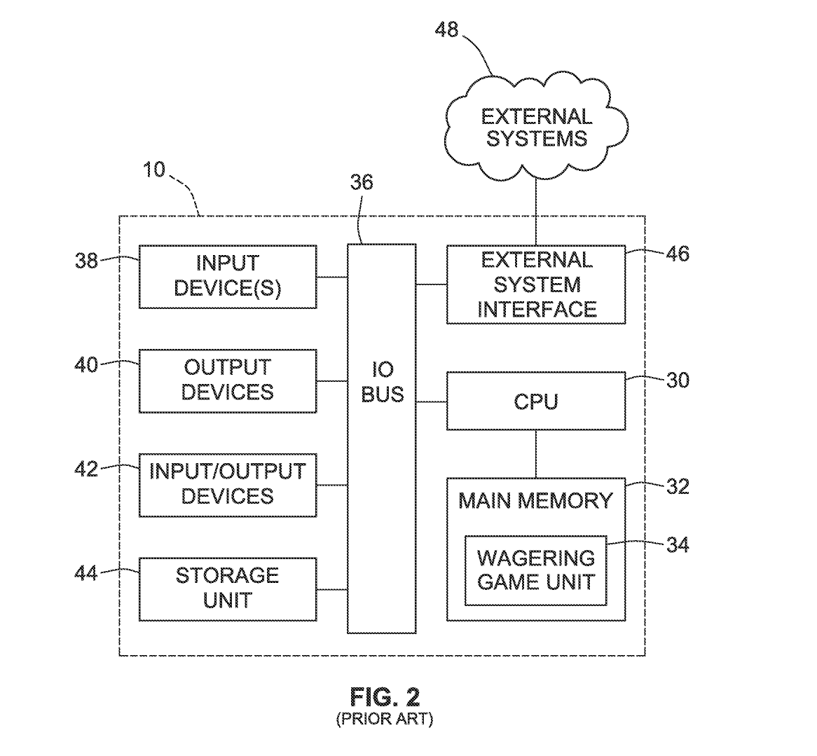

Turning now to FIG. 2, there is shown a block diagram of the gaming-machine architecture. The gaming machine 10 includes game-logic circuitry 28 having a central processing unit (CPU) 30 connected to a main memory 32. The CPU 30 may include any suitable processor(s), such as those made by Intel and AMD. By way of example, the CPU 30 may include a plurality of microprocessors including a master processor, a slave processor, and a secondary or parallel processor. Game-logic circuitry 28, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 28, and more specifically the CPU 30, comprises one or more controllers or processors and such one or more controllers or processors need not be disposed proximal to one another and may be located in different devices or in different locations. The game-logic circuitry 28, and more specifically the main memory 32, comprises one or more memory devices which need not be disposed proximal to one another and may be located in different devices or in different locations. The game-logic circuitry 28 is operable to execute all of the various gaming methods and other processes disclosed herein. The main memory 32 includes a wagering-game unit 34. In one embodiment, the wagering-game unit 34 may cause wagering games to be presented, such as video poker, video black jack, video slots, video lottery, etc., in whole or part.

The game-logic circuitry 28 is also connected to an input/output (I/O) bus 36, which can include any suitable bus technologies, such as an AGTL+ frontside bus and a PCI backside bus. The I/O bus 36 is connected to various input devices 38, output devices 40, and input/output devices 42 such as those discussed above in connection with FIG. 1. The I/O bus 36 is also connected to a storage unit 44 and an external-system interface 46, which may be connected to external system(s) 48 (e.g., wagering-game networks).

The external system 48 includes, in various aspects, a gaming network, other gaming machines or terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external-system interface 46 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 48 such that the gaming machine 10 operates as a thin, thick, or intermediate client. The game-logic circuitry 28—whether located within (“thick client”), external to (“thin client”), or distributed both within and external to (“intermediate client”) the gaming machine 10—is utilized to provide a wagering game on the gaming machine 10. In general, the main memory 32 (comprising one or more memory devices) stores programming for an RNG, game-outcome logic, and game assets (e.g., art, sound, etc.). When a wagering-game instance is executed, the CPU 30 (comprising one or more processors or controllers) executes the RNG programming to generate one or more pseudo-random numbers. The pseudo-random numbers are utilized by the CPU 30 when executing the game-outcome logic to determine a resultant outcome for that instance of the wagering game. The resultant outcome is then presented to a player of the gaming machine 10 by accessing the associated game assets, required for the resultant outcome, from the main memory 32. The CPU 30 causes the game assets to be presented to the player as outputs from the gaming machine 10 (e.g., audio and video presentations).

The gaming machine 10 may include additional peripheral devices or more than one of each component shown in FIG. 2. Any component of the gaming-machine architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

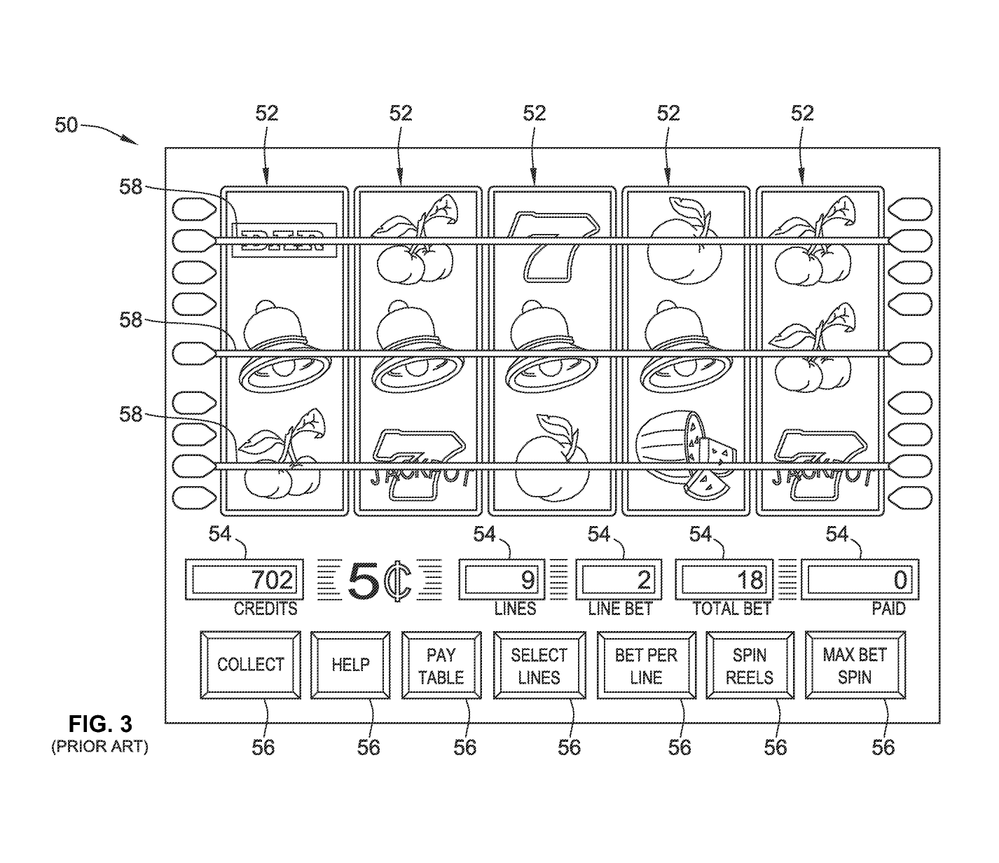

Referring now to FIG. 3, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The game-logic circuitry 28 operates to execute a wagering-game program causing the primary display area 12 or the secondary display area 14 to display the wagering game.

In response to receiving an input indicative of a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 12 or secondary display 14) through the display of information such as, but not limited to, text, graphics, static images, moving images, etc., or any combination thereof. In accord with the method of conducting the wagering game, the game-logic circuitry 28 transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the game-logic circuitry 28 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 30 causes the recording of a digital representation of the wager in one or more storage media (e.g., storage unit 44), the CPU 30, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU 30 (e.g., the wager in the present example). As another example, the CPU 30 further, in accord with the execution of the stored instructions relating to the wagering game, causes the primary display 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 28 to determine the outcome of the wagering-game instance. In at least some aspects, the game-logic circuitry is configured to determine an outcome of the wagering-game instance at least partially in response to the random parameter.

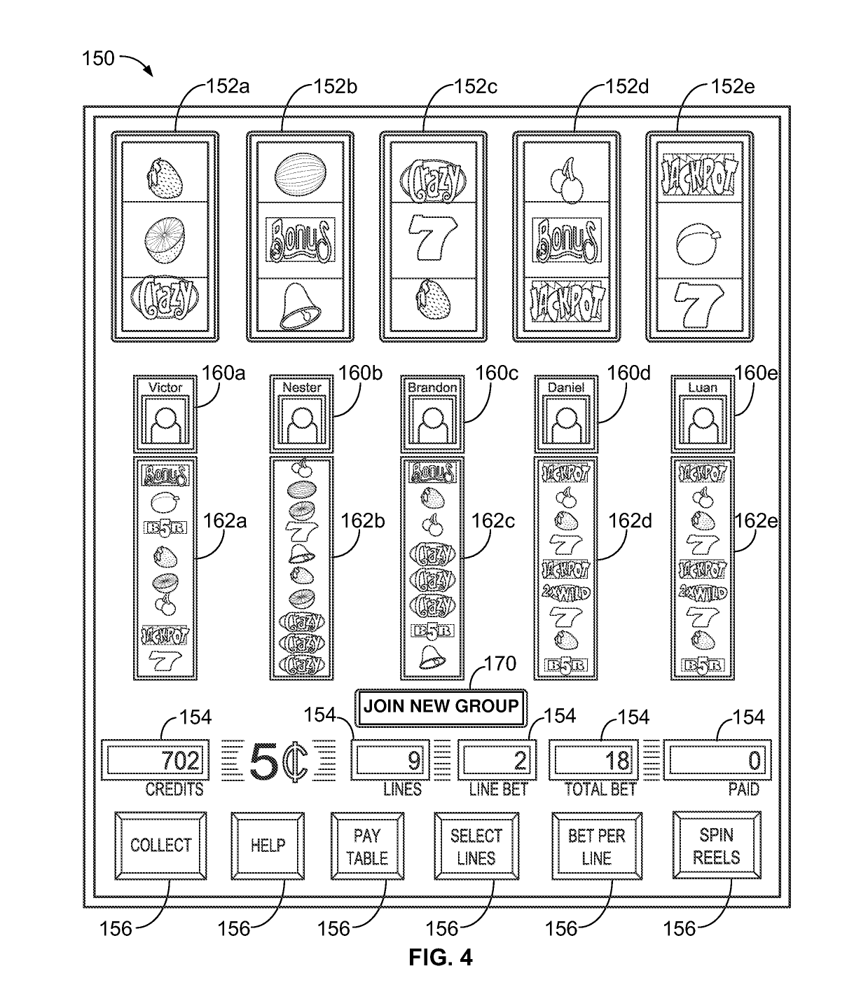

Referring now to FIG. 4, there is illustrated an image of another game screen 150 adapted to be displayed on the primary display area 12 or the secondary display area 14. Similar to the basic-game screen 50 described above, the game screen 150 in FIG. 4 presents a plurality of simulated symbol-bearing game reels 152a-e. The game screen 150 also includes game-session credit meters 154 and various selectable buttons 156, e.g., touch screen buttons, to receive input from a player. In response to player input via the buttons 156, the game-logic circuitry 28 executes a wagering-game program and causes the primary display area 12 or the secondary display area 14 to display a wagering game according to the game screen 150. Although the game screen 150 may be employed on a gaming machine 10 with display areas 12 and 14, it is contemplated that the game screen 150 and other aspects of the present invention may be employed in other contexts. For example, the game screen 150 may be employed in a social/casual game, where the game screen 150 may be presented through an online gaming website.

The game screen 150 allows a group of players to play together in a communal wagering game. Advantageously, the communal aspects of the wagering game enhance the gaming experience by allowing a group of players to interact with each other and to share in the excitement of playing a game. As shown in FIG. 4, the game screen 150 displays profiles 160a-e associated with the players playing the communal wagering game. The profiles 160a-e include images, e.g., profile pictures, and/or labels, e.g., player names, that identify each player. Although the game screen 150 identifies five players, it is understood that embodiments may accommodate any number of players. In addition, when necessary, the game screen 150 may present one or more computer-generated virtual players to ensure that there are enough players to continue with the communal wagering game. Indeed, it is contemplated that a single player may join a group where the other players are all computer-generated virtual players.

As shown in FIG. 4, each player is also associated with one of the player reels 162a-e. When the players join together to play the communal wagering game, the communal wagering game uses the player reels 162a-e to define the game reels 152a-e, which are rotated on the game screen 150 to determine an outcome. In other words, each player contributes a respective one of the player reels 162a-e to the combination of game reels 152a-e. For example, as shown in FIG. 4, player “Victor” identified by the profile 160a contributes the player reel 162a which is used for the game reel 152a; player “Nester” identified by the profile 160b contributes the player reel 162b which is used for the game reel 152b; and so on.

Similar to the basic-screen game 50 described above, the player can operate the selectable buttons 156 to enter wagers for each spin of the game reels 152a-e, and the meters 154 provide information relating to the wagers. For example, when the players have all entered their wagers and indicated that they are ready, e.g., by selecting “SPIN REELS,” the game reels 152a-e are rotated and stopped to place the symbols on the game reels 152a-e in visual association with paylines (not shown). The communal wagering game evaluates the displayed array of symbols on the stopped reels and provides awards in accordance with a pay table. The players are provided with awards based on their respective wagers and the shared outcome provided by the game reels 152a-e.

As used herein, the term “player reel” generally refers to a reel that is associated with a particular player and that the player can contribute to a wagering game for use as a game reel. Additionally, the term “game reel” generally refers to a reel that is rotated on a game screen to determine an outcome for a wagering game. Furthermore, the term “communal wagering game” generally refers to any wagering game in which a player interacts with other players by contributing one or more player reels, which are then used as game reels to determine an outcome. In general, player reels are employed as an instrument to generate social interaction between players in a communal wagering game.

In some embodiments, players can maintain electronically stored accounts to maintain their individual profiles and player reels. Accordingly, the players can conveniently access their accounts to use the same individual profiles and player reels every time they play the communal wagering game. In some cases, a player's account may be tied to the player's membership in a loyalty program associated, for example, with a gaming establishment. In other cases, a player's account may be tied to the player's membership in a gaming community associated, for example, with an online gaming website. Alternatively, if a player does not want to create an electronically stored account, the player can create a guest profile to be used for an entire gaming session, and a player reel can be assigned to the guest profile.

As also shown in FIG. 4, the game screen 150 also includes a “JOIN NEW GROUP” button 170 that allows a player to leave the group on game screen 150 and join another group. When a player selects the “JOIN NEW GROUP” button 170, his/her respective player reel is removed from the combination of game reels 152a-e. In some cases, to enable selection of the “JOIN NEW GROUP” button 170, the player may be required to provide some type of payment, e.g., credits, or social money for a social/casual communal wagering game. In other cases, the player may use loyalty points that the player has earned in a loyalty program associated, for example, with a gaming establishment. In yet other cases, the player may use bonus awards that the player has earned during previous gameplay.

In some embodiments, the communal wagering game automatically and randomly assigns the player to a new group in response to the selection of the “JOIN NEW GROUP” button 170. Once the player is assigned to the group, the player is presented with a new game screen (similar to the game screen 150) corresponding to a new group of players, each of which contributes a player reel.

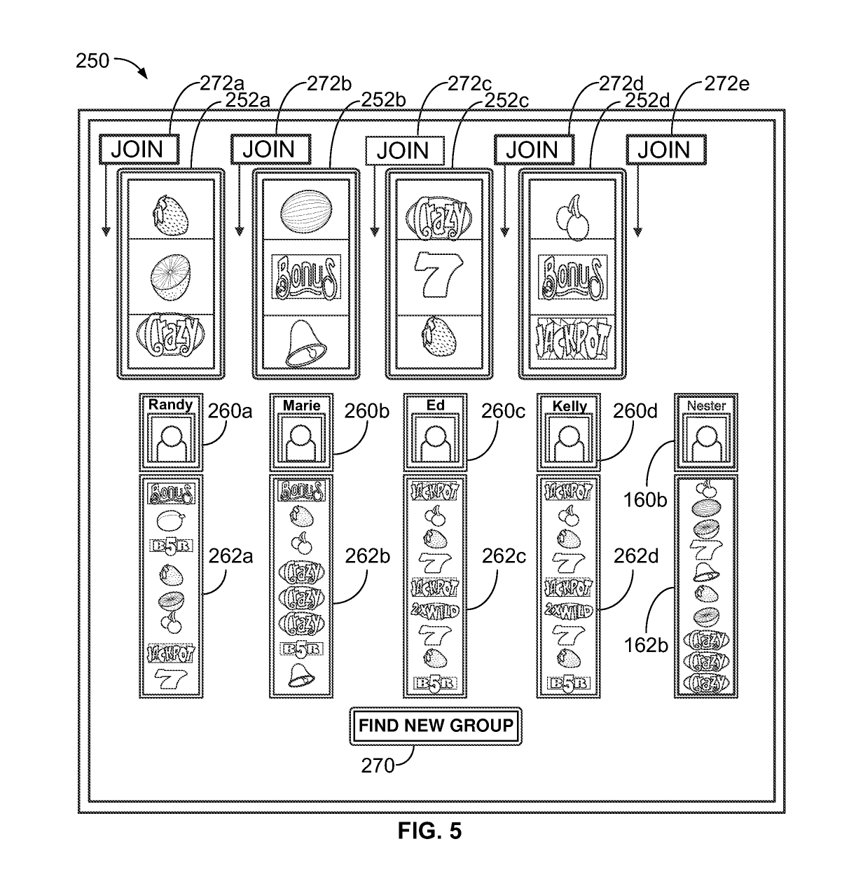

In other embodiments, the player is permitted to select the group that he/she will join. The communal wagering game presents the player with a plurality of groups that need one or more additional players to satisfy the total number of player reels required to play the game. For example, FIG. 5 illustrates a selection screen 250 with a group that includes four players. The four players are identified by profiles 260a-d and have contributed player reels 262a-d to the game reels 252a-d, respectively. Thus, the group shown in the selection screen 250 needs one more player to join and contribute a fifth player reel in order to achieve the five total reels required to play the communal wagering game. Here, the player “Nestor” who is associated with the profile 160b and the player reel 162b in the game screen 150 shown in FIG. 4 has decided to leave the group in the game screen 150. The selection screen 250 also displays the player's profile 160b and player reel 162b. If the player joins the group in the selection screen 250, gameplay can begin and all players in the group are presented with a new game screen (similar to the game screen 150). If the player does not want to join the group displayed by the selection screen 250, the player can move on to other selection game screens by selecting the “FIND NEW GROUP” button 270 to find another group to join.

In some embodiments, the communal wagering game can provide a player with suggestions on which group(s) to join. For example, the communal wagering game may determine what groups may likely benefit from the contribution of the player's player reel. In some cases, the player is first directed to such groups when the player moves from a screen.

Advantageously, embodiments of the communal wagering game make the gaming experience more dynamic by allowing players to move to different groups. By moving to different groups, players interact with different combinations of players and experience greater variety with different reel combinations. In addition, the option to move to different groups may give players the perception that they can control their chances of winning. For example, if a group does not appear to be winning, a player in that group may try to change his/her luck by moving to another group. In general, a player reel can be associated with a particular player, and this association is electronically stored, e.g., in an account, so that the player can use the same player reel with different groups, i.e., the player reel follows the player as the player moves from group to group.

As described above, the group of players in the communal wagering game share in the outcome of at least one rotation of the game reels that are defined by the player reels contributed by the players. In some embodiments, a player may be required to play with the group for a minimum number of spins (e.g., 10 spins) before the player is permitted to move to another group. This helps to establish some continuity within the gaming system and may minimize the number of groups that are simultaneously looking for new players to join.

Because gaming terminals and/or game screens for wagering games may have different themes and graphical features based on stories, characters, TV shows, movies, video games, board games, pop culture, etc., player reels may be modified to match the respective theme or visual features when players contribute the player reels to a communal wagering game. Alternatively, the player reels may be sufficiently generic to accommodate the themes and graphical features of a variety of communal wagering games.

As described above, the communal wagering game evaluates the displayed array of symbols on the stopped game reels 152a-e and provides awards in accordance with a pay table. Thus, the awards depend on the symbols provided by the player reels 162a-e. Accordingly, before deciding to join a group, a player may evaluate whether his/her player reel can increase the likelihood of achieving a winning outcome when combined with the other player reels in the particular group. For example, in FIG. 5, the player “Nestor” may evaluate the symbols on the player reels 262a-d relative to his own player reel 162b. To help the player evaluate the symbols on the player reels 162b and 262a-d, the player reels 162b and 262a-d may rotate on the selection screen 250 to reveal some or all of their respective symbols. If the collection of symbols on the player reel 162b appears to provide favorable combinations with the other player reels 262a-d, the player may decide to join the group. For example, the player may determine that the other player reels 262a-d may include many “WILD” symbols. “WILD” symbols can be used to represent any symbol that achieves the most favorable combination with the other symbols along a payline. As such, the player may conclude that, with these “WILD” symbols, winning symbol combinations can be more easily achieved if he joins the group.

In addition, the pay table may include “line pays,” which occur when a predetermined type and number of symbols appear along an activated payline, typically in a particular order such as left to right, right to left, top to bottom, bottom to top, etc. Thus, the awards may also depend on how the player reels 162a-e are ordered to define the game reels 152a-e. If the player “Nestor” does indeed decide to join the group on the selection screen 250, he may be required to determine where his player reel 162b must be positioned relative to the game reels 252a-d. As shown in FIG. 5, the player can select any one of the “JOIN” buttons 272a-e to join the group and select where his player reel 162b should be located. For example, if the “JOIN” button 272c is selected, the player reel 162b is used to define a reel between reels 252b and 252c in the resulting game screen. In some embodiments, due to the benefits that may be gained by placing the player reel 162b in some positions, the player may be required to make some type of payment, exchange loyalty points from a loyalty program, redeem bonus awards from prior gameplay, etc., to select a particular position for the player reel 162b. For example, it may be more difficult to contribute a winning symbol when the player reel is used at locations on the right side of the game reels 252a-d. In alternative embodiments, the player may not be permitted to select the position of the player reel; instead, the communal wagering game may randomly select a position for the player reel or the player reel may be assigned to an unchangeable designated position.

As described above, the communal wagering game evaluates the displayed array of symbols on the stopped game reels and provides awards in accordance with a pay table. In some embodiments, a player may receive an additional bonus if he/she contributes a player reel that is significant in achieving a winning outcome. For example, if the player contributes a player reel with a rare symbol without which there would not have been a winning outcome, the player receives a bonus. Additionally or alternatively, the player may receive an additional bonus according to the position of his/her player reel among the game reels. For example, the player may receive a greater bonus if his/her player reel is positioned on the right side of the game reels, because it is more difficult to contribute a winning symbol from the right side position.

As described above, the player reels 162b and 262a-d may rotate on the selection screen 250 shown in FIG. 5 to reveal some or all of their respective symbols. In some embodiments, the selection screen 250 may make the symbols of the player reels 162b and 262a-d less obvious. For example, the selection screen 250 may rotate only through certain parts of the player reels 162b and 262a-d so that the player cannot see all of the symbols. Additionally or alternatively, the selection screen 250 may rotate the player reels 162b and 262a-d at a higher speed so that their symbols are more difficult to discern. Additionally or alternatively, selected symbols on the player reels 162b and 262a-d may be hidden.

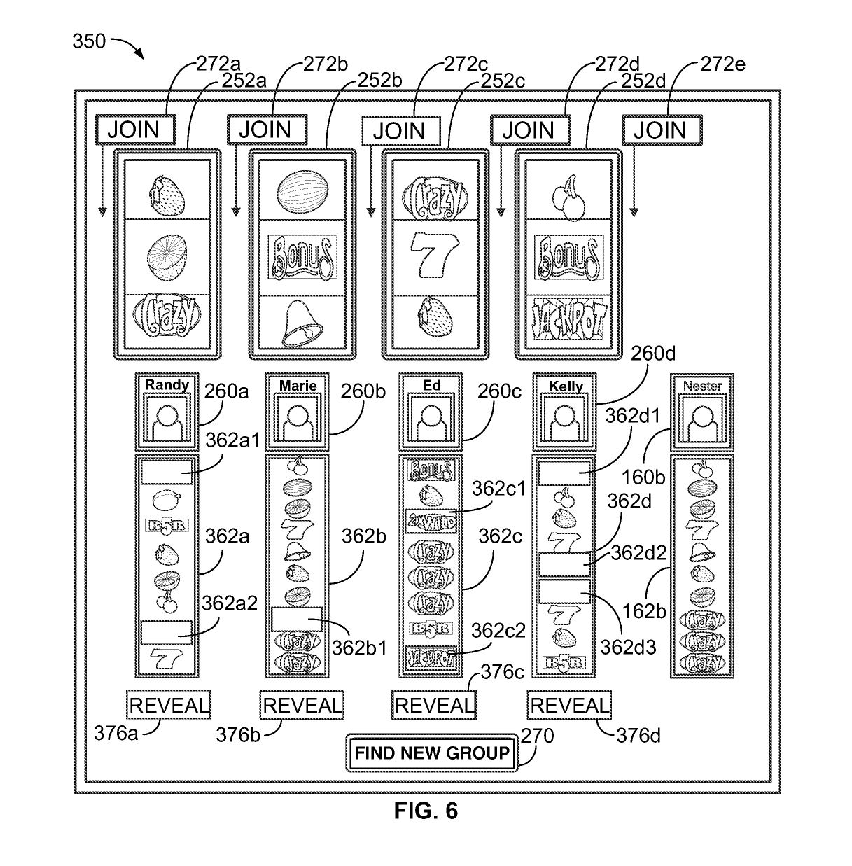

In some embodiments, the player may be have an option to request the selection screen to display more symbols on the player reels and/or to make it easier to discern symbols on the player reels. FIG. 6, for example, illustrates a selection screen 350 similar to the selection screen 250. Here, the player knows all of the symbols on his own player reel 162b, so the selection screen 350 rotates through the entire player reel 162b at a slower speed to make it easy to discern all of its symbols. The selection screen 350, however, hides selected symbols on the other player reels 362a-d associated with the profiles 250a-d, respectively. For example, symbols of greater value, such as “WILD” symbols, may be among the selectively hidden symbols to make it more difficult to evaluate the other player reels 362a-d.

As shown in FIG. 6, the selection screen 350 hides the symbols 362a1 and 362a2 on the player reel 362a, the symbol 361b1 on the player reel 362, and the symbols 362d1, 362d2, and 362d3 on the player reel 362d. The selection screen 350, however, also includes “REVEAL” buttons 376a-d associated with the player reels 362a-d, respectively. The player may select one or more of the “REVEAL” touch screen buttons 376a-d to gain more information about the player reels 362a-d. As shown in FIG. 6, the “REVEAL” button 376c has been selected to reveal the previously hidden symbols 362c1 and 362c2 on the player reel 362c. Additionally or alternatively, selecting a “REVEAL” button causes the game screen to rotate through more parts of the respective player reel. Additionally or alternatively, selecting a “REVEAL” button slows down the speed at which the respective player reel rotates to make its symbols easier to discern.

In general, embodiments may provide an option that allows players to gain more information about player reels. In some cases, the player may be required make some type of payment, exchange loyalty points from a loyalty program, redeem bonus awards from prior gameplay, etc., to obtain such information.

In some embodiments, each player may be associated with one particular player reel which the player can use as he/she moves from group to group. The player, for example, may receive his/her own player reel the first time he/she plays the communal wagering game. However, it is contemplated that a player may collect any number of player reels with different combinations of symbols. The player can then use any one of these reels when joining a group. Indeed, the player can join any number of groups using a different player reel from his/her collection. Furthermore, it is contemplated that a player may contribute more than one player reel to a group.

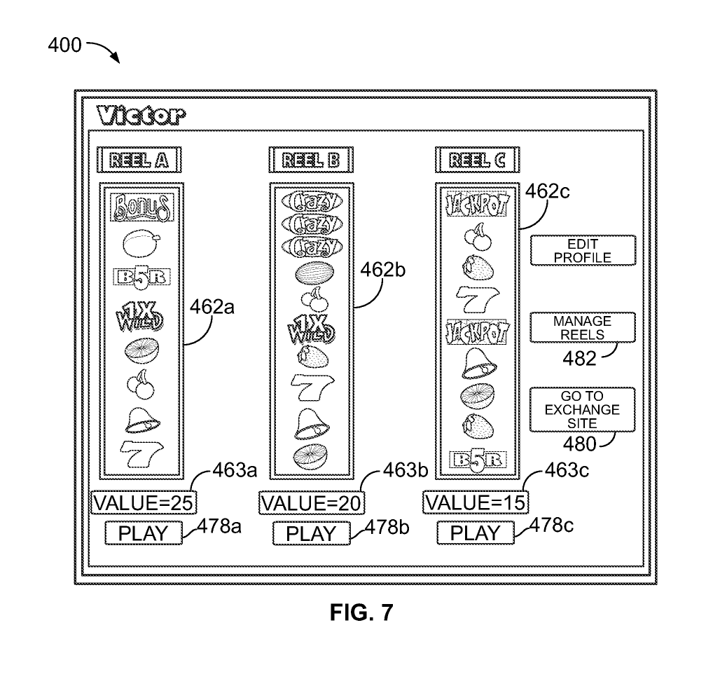

For example, FIG. 7 illustrates an account screen 400 that displays player reels 462a-c associated with a player “Victor.” The player reels 462a-c may rotate on the account screen 400 to allow the player to see all the symbols along the player reels. The account screen 400 includes “PLAY” buttons 478a-c associated with the player reels 462a-c, respectively. By selecting one of the “PLAY” buttons 478a-c, the player “Victor” can select the respective player reel and join a group. For example, in response to the selection of the “PLAY” button, the communal wagering game may present the player with selection screens, such as the selection screens 250 and 350 described above, where the player can decide to join a group with the player reel selected in the account screen 400. Alternatively, the communal wagering game may automatically put the player into a group with the reel selected in the account screen 400.

Players may collect player reels according to any combination of approaches. For example, a player may win additional player reels as bonus awards when playing the communal wagering game. The player may earn additional player reels for playing the communal wagering game a certain number of times. The player may earn additional player reels by maintaining an active account for the communal wagering game for a certain amount of time. The player may earn additional player reels by recruiting additional people to play the communal wagering game. To collect additional player reels, the player may be required to make some type of payment, exchange loyalty points from a loyalty program, redeem bonus awards from prior gameplay, etc. Allowing players to collect more than one player reel requires the player to develop a strategy for determining which player reels to use and when to use certain player reels. Advantageously, requiring the use of such strategy enhances player interest in the communal wagering game.

In some embodiments, players may be able to collect additional player reels through one or more exchange sites. Such exchange sites may allow players to buy, trade, sell, give away, and/or auction player reels. For example, the exchange site may be presented on a screen displayed by the communal wagering game. As shown in FIG. 7, for example, the player can select the “GO TO EXCHANGE SITE” button 480 on the account screen 400 to go to another screen where the player can interact with other players to exchange player reels. In another example, the exchange site may be a website or electronic forum associated with a community of players devoted to the communal wagering game. Advantageously, the active exchange of player reels encourages interaction between players and further enhances interest in the communal wagering game.

Single player reels may be bought, traded, sold, given away, and/or auctioned. Alternatively, a plurality of player reels may be bought, trades, sold, given away, and/or auctioned together in combination. For example, player reels may be electronically combined into a trading package that is similar to a package of trading cards, e.g., baseball cards, where the contents of the package are not known until the package is accessed. Players can keep some of the player reels received in the trading package, while selling, trading, giving away, and/or auctioning the other player reels. Indeed, it is contemplated that player reels may be exchanged like trading cards. In some embodiments, rather than receiving a single player reel, players may receive trading packages containing player reels when they first play the communal wagering game. In further embodiments, the trading packages may include other contents as described further below. For example, the trading packages may include one or more placement cards that determine where one or more of the player reels may, or must, be positioned among the game reels on a game screen.

The exchange of player reels may require a value to be placed on each player reel to help a player determine whether an even exchange is being proposed. For example, a player reel with more “WILD” symbols and other symbols required for larger awards according to a pay table may have a higher value than other player reels. Thus, the value of a player reel may be determined by the types of symbols on the player reel. Additionally, a player reel may also gain value based on prior play. For example, a player reel that has produced more winning outcomes may gain value.

A combination with higher value player reels generally provides or appears to provide a greater probability for a winning outcome. The value reflects the strength or power of the player reel. In some cases, the communal wagering game may calculate and display values for player reels. For example, the account screen 450 presents “VALUE” meters 463a-c with calculated values for the player reels 462a-c, respectively. The values in the meters 463a-c may reflect the relative strength or ability of the respective player reel to contribute to a winning outcome. Alternatively, the values may be a (normalized) result from a probability calculation.

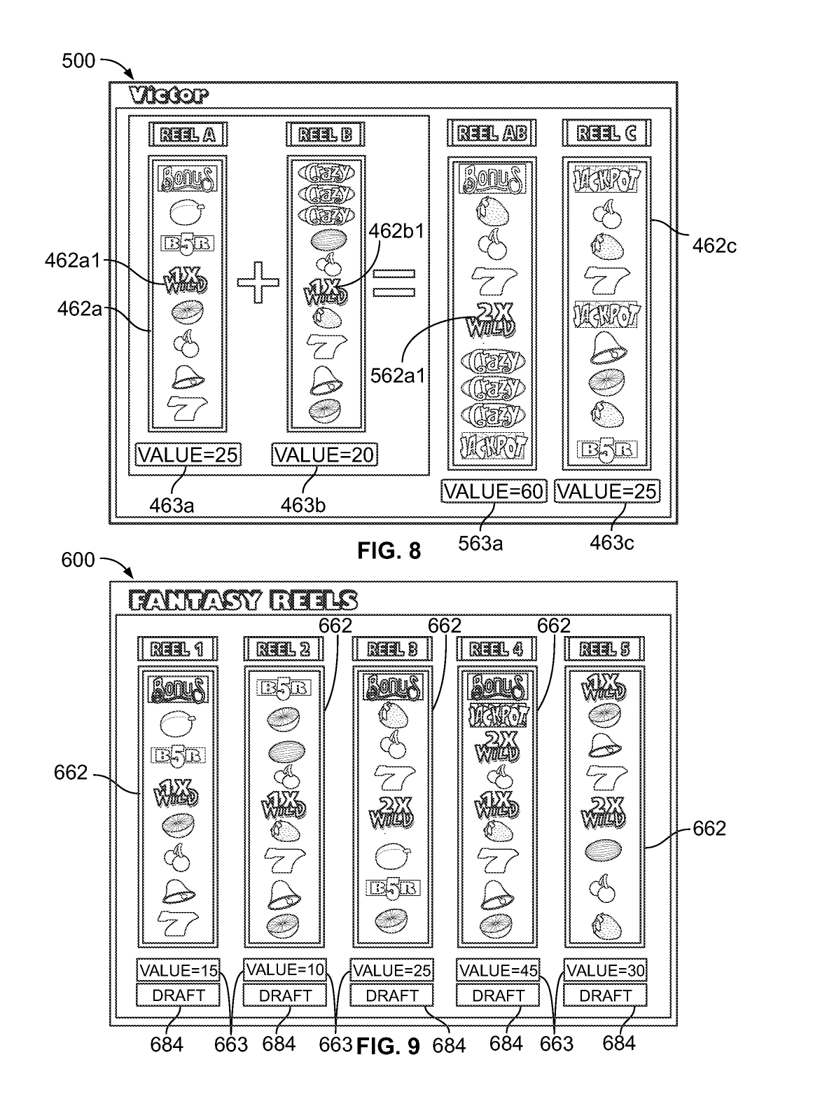

In some cases, a player may obtain a higher value player reel through an exchange with another player or the gaming system. Higher value player reels generally require more in exchange, e.g., greater payment. In some embodiments, a player may be able to obtain a higher value player reel after collecting and trading in a certain number of player reels of lower value. In some cases, the symbols on the lower value player reels may be combined in some way to define symbols on the higher value player reel. For example, FIG. 8 illustrates another account screen 500, which can be called up, for example, by selecting a “MANAGE REELS” button 482 on the account screen 400 shown in FIG. 7. The account screen 500 includes the player reels 462a-c and their respective “VALUE” meters 463a-c from the account screen 400. The account screen 500, however, indicates that the player reels 462a and 462b have been combined to produce a player reel 562a. The account screen 500 also includes a “VALUE” meter 563a for the player reel 562a, which indicates that the value of the new player reel 562 is higher than those of the player reels 462a and 462b. In addition, FIG. 8 shows that the “1X WILD” symbol 462a1 on the player reel 462a and the “1X WILD” symbol 462b1 on the player reel 462b are combined to define a “2X WILD” symbol 562a1 on the new player reel 562a. The player may initiate the combination of the player reels 462a and 462b by selecting a corresponding input button (not shown), dragging one of the player reels onto the other player reel, etc. Alternatively, the communal wagering game may automatically combine the player reels 462a and 462b, because they meet some criteria, e.g., they both have “1X WILD” or other symbols.

In some embodiments, a player may be able to enhance the value of an existing player reel by replacing symbols on the player reel. For example, the player may obtain a “WILD” symbol that can replace another symbol on the player reel. The new symbols can be obtained, for example, by making some type of payment, exchanging loyalty points from a loyalty program, redeeming bonus awards from prior gameplay, etc.

As discussed above, in some embodiments, additional bonuses may be provided to a player if the player contributes a player reel that is significant in achieving a winning outcome for a group. In some cases, bonuses may be paid to the player based on the value of the player reel, because higher value player reels increase the chances for a winning outcome. Thus, a player who contributes a higher value player reel receives a greater bonus if there is a winning outcome. Such bonuses encourage players to contribute higher value reels to the group.

Aspects of the present invention may impose restrictions to ensure that the expected value for the communal wagering game generally remains in a certain range. In some embodiments, players are grouped together based on the values of their player strips. For example, players with high value player reels may be prohibited from combining their player reels together. The communal wagering game may prohibit a game screen from using player reels that are greater than a predetermined value. The communal wagering game may restrict the total value of player reels allowed for a group of players. The communal wagering game may require higher wagers if there are high value player reels.

In yet other embodiments, the expected value may be adjusted in response to the value of the player reels on a game screen. For example, the player reels may include mystery symbols that can be used to adjust the expected value of the game reels. Alternatively, the number of spins in a round for a group having high value reels can be restricted according to the total value of the player reels. In other words, a combination of high value player reels may be permitted by the number of spins may be limited to reduce the total award amount that may be won by the players over a round or session.

In some embodiments, the value of a particular player reel can be increased with a booster. For example, the symbols on a player reel may be modified with a booster so that the player reel has more symbols that may result in higher awards, e.g., “WILD” symbols. Boosters may be awarded to reward players for particular types of activity. In some cases, a player may receive one or more boosters as a reward for engaging in social interaction with other players. Such interaction may include joining more than one group of players to play the communal wagering game, inviting new players to play the communal wagering game, exchanging player reels with other players, participating in different formats of the communal wagering game, etc. In other cases, to boost the value of the player reel, the player may be required to make some type of payment, exchange loyalty points from a loyalty program, redeem bonus awards from prior gameplay, etc. In yet other cases, boosters can be exchanged like player reels as described above to encourage social interaction between players. Indeed, a booster may be included in a trading package like a piece of gum in a traditional package of trading cards.

In embodiments where players can collect additional player reels, the player reels may expire. Thus, if a player collects duplicate player reels, each of the duplicate player reels has value. For example, a player reel may expire after a certain amount of time, e.g., six hours, one day, one week, etc., and/or after it is used for a certain number of spins, e.g., one spin, 20 spins, etc. A player reel can no longer be used once it expires. Causing player reels to expire also requires the player to develop a strategy for determining which player reels to use and when to use certain player reels. Requiring the use of strategy enhances player interest in the communal wagering game.

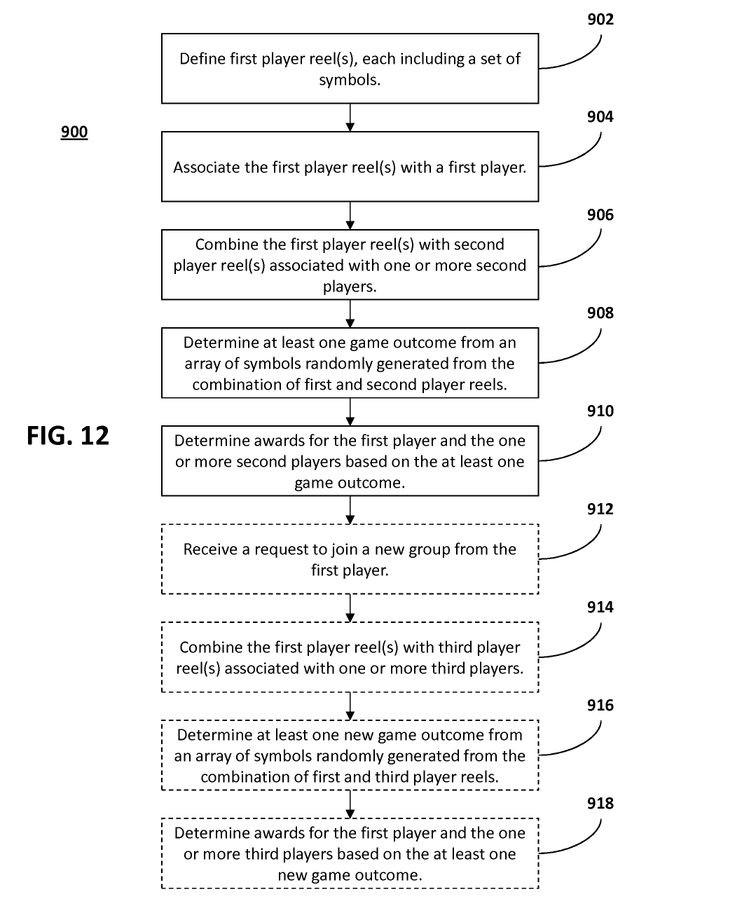

In some cases, a player may be allowed to pass a player reel to another player after it has expired. Allowing a player to pass a player reel to another player advantageously encourages social interaction between players. As shown in FIG. 11, a query screen 700 is shown to a player after a player reel 762 has expired. A corresponding life meter 786 shows that the player reel 762 has “0%” life remaining. The query screen 700 informs the player that the player reel 762 has expired and asks the player what he/she would like to do with the player reel 762. The player may select the “PASS” button to pass the player reel 762 to another player. The life of the player reel 762 is restored to some value greater that zero, e.g., “50%,” “100%,” etc., when the other player receives the player reel 762. Alternatively, the player may select the “KEEP/EXTEND” button if he/she wants to keep the player reel 762. To help the player decide whether to keep the player reel 762, the query screen 700 also includes a “VALUE” meter 763.

To keep the player reel 762, the player must extend the life of the player reel 762. For example, to restore the life of the player reel 762 to some value greater that zero, e.g., “50%,” “100%,” etc., the player may be required to some type of payment, e.g., credits, or social money for a social/casual communal wagering game. The player may extend the life of the player reel 762 in exchange for loyalty points that the player has earned in a loyalty program. The player may extend the life of the player reel 762 in exchange for another player reel. The player may extend the life of the player reel 762 if a particular symbol appears in one of the player's other player reels. The player may be able to extend the life of the player reel 762 if the player wins a particular bonus award when playing the communal wagering game. In some embodiments, extensions can be exchanged like player reels as described above to encourage social interaction between players. Indeed, an extension may be also included in a trading package like a piece of gum in a traditional package of trading cards.

Embodiments of the communal wagering game may employ various modes of gameplay. As described above, a single player may use a player reel to join a group of other players and win awards based on the shared outcome of one or more spins of the game reels on a common game screen. In alternative embodiments, the set of game reels required for a game screen are defined using one or more player reels contributed by a single player. In other words, the single player does not combine his/her player reels with those of other players to define a game screen. In some cases, the player reel(s) from the single player may be combined with one or more computer-generated game reels presented by the game screen. The single player can then compete against other players who have similarly contributed their own player reel(s) to define the set of game reels required for their own respective game screens.

In some cases, players may compete against each other in head-to-head matchups. In other cases, players may compete against two or more players at the same time. The players may compete against each other in one or more rounds, where one round may include one or more spins.

In some cases, the players may compete against each other in a league, e.g., round-robin, format, which may include playoffs and a championship matchup. In other cases, the players may compete against each other in a tournament format. The player may be required to use player reels that are assigned by the communal wagering game when he/she signs up for the league or tournament. Alternatively, a player may be permitted to use player reels that he/she has collected previously and that are stored in an account.

For a competition between two or more players, the players may win, lose, or otherwise be ranked according to the outcome(s) of their respective game reels. For example, the outcome for each player may be based on the award, e.g., credits, provided in response to a wager by the player, where the displayed array of symbols on the stopped game reels is evaluated with a pay table. In some cases, the winner of a round is the player who receives the largest award total, e.g., total credits, over the number of spins in the round. In other cases, a player earns a point every time the player receives the highest award for a single spin, and the winner of the round is the player who receives the greatest number of points over a plurality of spins in the round. Alternatively, the players may receive ranking points based on the award received for each spin, and the winner of the round is the player who receives the greatest number of points over a plurality of spins in the round.

In other embodiments, a group of players may combine their player reels to compete against other groups, where other awards may be gained by winning against other groups. Like competitions between individual players, groups in some cases may compete against each other in head-to-head matchups. In other cases, groups may compete against two or more groups at the same time. The groups may compete against each other in one or more rounds, where one round may include one or more spins. In some cases, the groups may compete against each other in a league, e.g., round-robin, format, which may include playoffs and a championship matchup. In other cases, the groups may compete against each other in a tournament format. Similar to a competition between two or more players, the groups may win, lose, or otherwise be ranked according to the outcome(s) of their respective game reels.

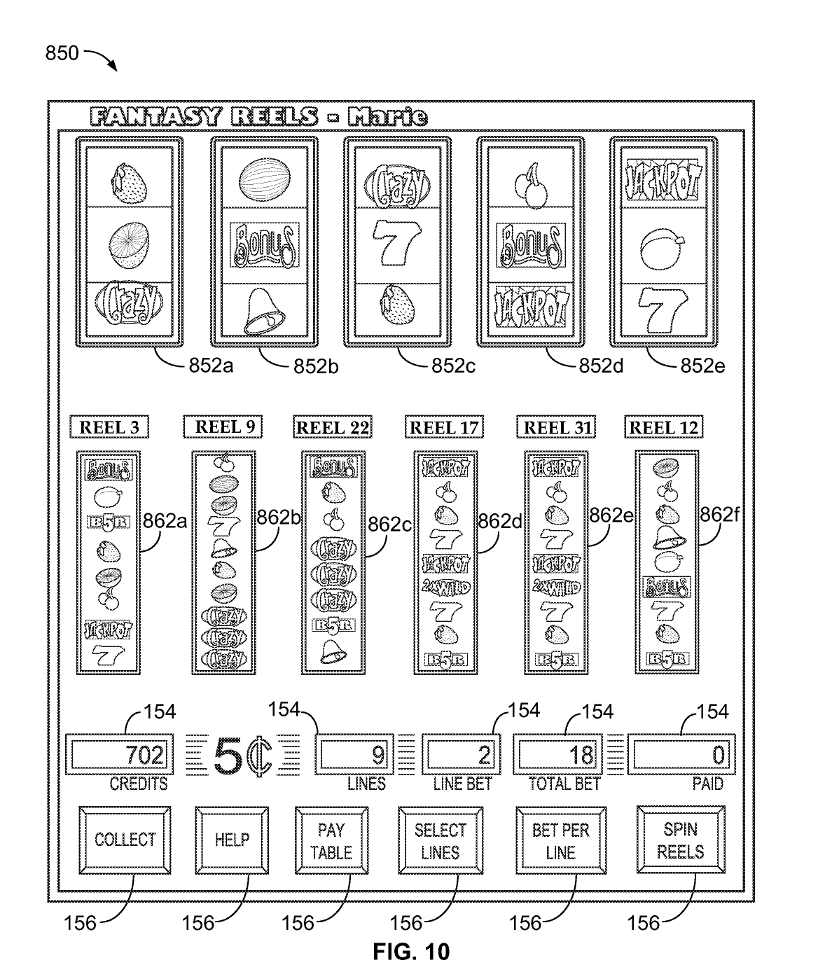

In an example mode of gameplay, the communal wagering game may employ aspects of fantasy sports to encourage interaction between players and further enhance interest in the communal wagering game. In particular, players may be able to collect player reels by participating in a draft, where each player takes turns drafting a player reel from a selection of player reels. As shown in FIG. 9, a draft screen 600 includes a plurality of player reels 662. The player reels 662 may rotate on the draft screen 600 to allow the player to see some or all the symbols along the player reels. Taking turns according to a predetermined order, one player collects one of the player reels 662, the next player collects one of the remaining player reels 662, and so on. In the embodiment of FIG. 9, the players select a player reel 662 by selecting a respective “DRAFT” button 684 as shown in the draft screen 600. The draft screen 600 also includes a “VALUE” meter 663 for each of the player reels 662 to help the player determine which player reel 662 to select among the remaining available player reels 662. In some embodiments, the players are permitted only to collect a set of player reels 662 whose combined values do not exceed a cap value. In some cases, the cap value may set a maximum value for the expected value of the player reels drafted by a player. The cap value is similar to a salary cap used in fantasy sports drafts. The cap rule helps ensure that the quality of the player reels 662 is more or less distributed evenly across all players. The cap rule also requires the players to exercise some strategy. For example, to satisfy the cap rules, one player may collect a combination of higher value player reels and lower value player reels, while another player may collect a combination of medium value player reels.

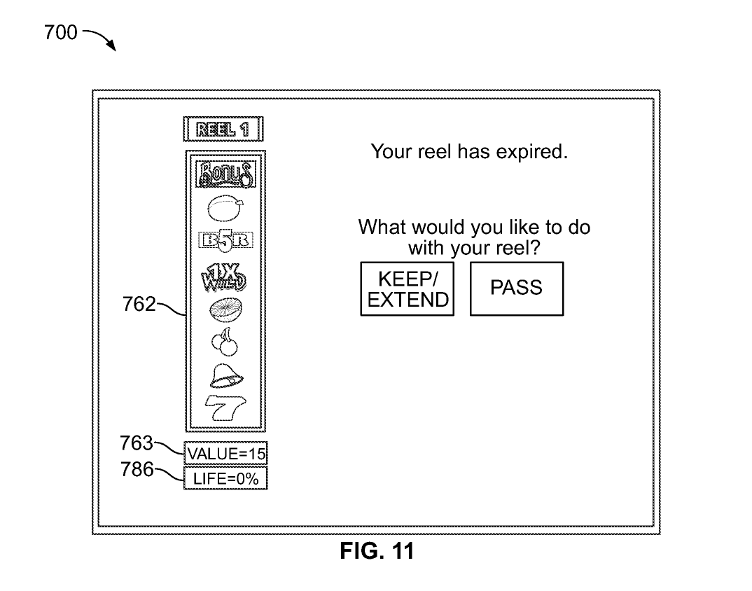

In some embodiments, a player can select one of his/her drafted player reels and contribute that selected player reel to a combination of player reels from other players in order to play the communal wagering game as illustrated in FIG. 4. In alternative embodiments, each player in the draft combines his/her own drafted reels to play against the combinations of player reels from other players in the draft. As shown in FIG. 10, the game screen 850 presents six player reels 862a-f drafted by player “Marie.” The player has selected five of the player reels 862a-f to be combined for game reels 852a-e. Additionally, the player has determined the order of the selected player reels 862a-e for the game reels 852a-e. The game reels 852a-e are rotated to determine an outcome for the player “Marie.” Unlike the game screen 150 shown in FIG. 4, the game reels 852a-e are all contributed by a single player. Meanwhile, each of the other players in the draft has a similar game screen, where the player selects five drafted player reels to be combined for game reels, which are then rotated to determine an outcome. It is understood that embodiments may employ any number of player reels and game reels. In some cases, for example, the player may be required to play all drafted player reels, rather than allowing the player to select a subset for gameplay.

Accordingly, each player is associated with one or more outcomes which are determined by his/her own combination of game reels selected from a draft. The outcome(s) for a player depend(s) on what player reels are drafted by the player and how the player selects and orders a subset of drafted player reels to define the game reels. As described above, it is contemplated that aspects of fantasy sports may be employed to encourage interaction between players and further enhance interest in the communal wagering game. Similar to drafting players in a sports league and selecting a subset of drafted players to fill a roster for fantasy gameplay, the players in this example draft player reels and select a subset of drafted player reels for wagering gameplay.

As described above, the players participating in the draft may compete against each other in a variety of formats. In some cases, players may compete against each other in head-to-head matchups. In other cases, players may compete against each other in groups of three or more players. The players may compete against each other in one or more rounds, where one round may include one or more spins. In some cases, the players may compete against each other in a single round of one or more spins. In other cases, the players may compete against each other in a league, e.g., round-robin, format, which may include playoffs and a championship matchup. In other cases, the players may compete against each other in a tournament format. In other formats, a group of players may join together to draft a team and compete against other teams as described above.

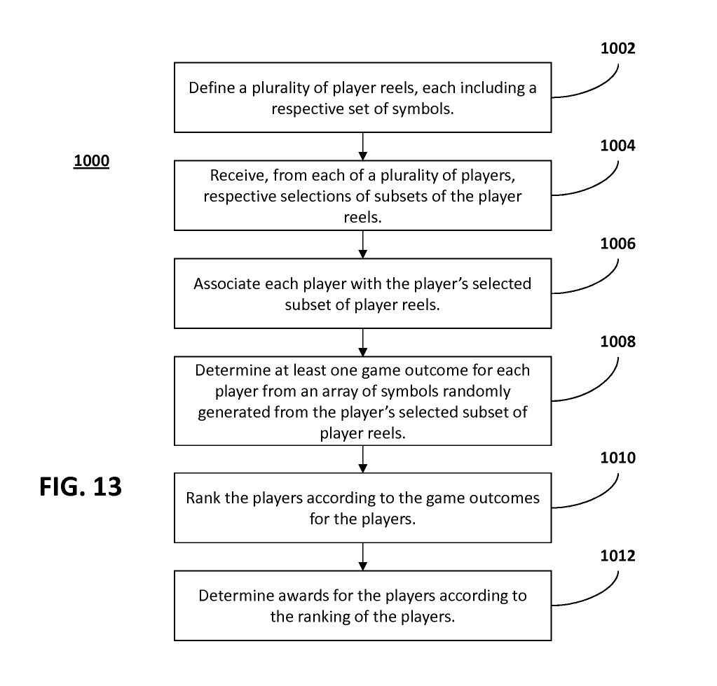

FIG. 12, described by way of example above, represents an approach 900 that corresponds to at least some instructions stored and executed by the game-logic circuitry 28 in FIG. 2 to perform the above described functions associated with the disclosed concepts. In act 902, first player reel(s) are defined, where each first player reel includes a set of symbols. In act 904, the first player reel(s) are associated with a first player. In act 906, the first player reel(s) are combined with second player reel(s) which are associated with one or more second players. Each second player reel also includes a set of symbols. In act 908, at least one game outcome is determined from an array of symbols randomly generated from the combination of the first player reel(s) and the second player reel(s). In act 910, awards are determined for the first player and the one or more second players based on the at least one game outcome. Thus, in the approach 900, the first player and the one or more second player(s) contribute respective player reels which are used to determine game outcomes that are shared by all players and used to determine awards for all players.

As shown further in FIG. 12, the approach 900 may also include optional acts 912-918. Specifically, in act 912, a request to join a new group is received from the first player. In act 914, the first player reel(s) are combined with third player reel(s) associated with one or more third players. Each third player reel also includes a set of symbols. In act 916, at least one new game outcome is determined from an array of symbols randomly generated from the combination of the first player reel(s) and the third player reel(s). In act 918, awards are determined for the first player and the one or more third players based on the at least one new game outcome. Thus, in the approach 900, the first player can move from the one or more second player(s) and join one or more third player(s) to determine new game outcomes from a new combination of player reels.

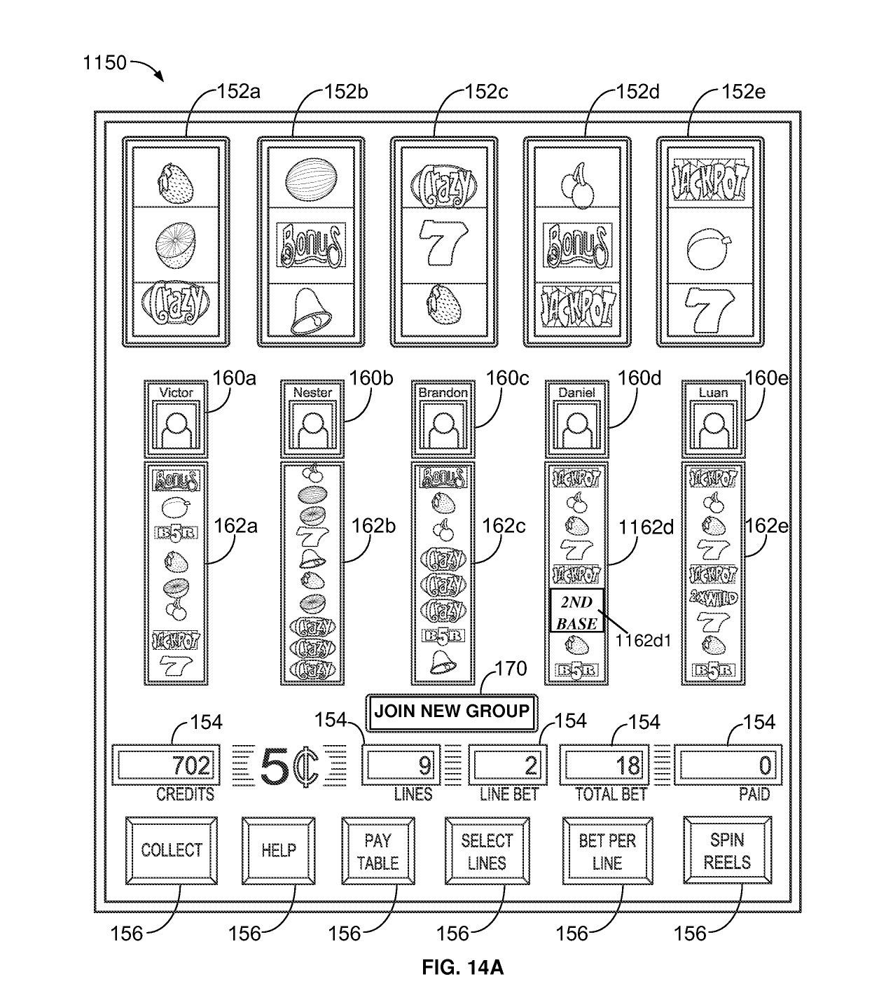

FIG. 13, also described by way of example above, represents another approach 1000 that corresponds to at least some instructions stored and executed by the game-logic circuitry 28 in FIG. 2 to perform the above described functions associated with the disclosed concepts. In act 1002, a plurality of player reels is defined, where each player reel includes a respective set of symbols. In act 1004, a respective selection of a subset of the player reels is received from each player. In act 1006, each player is associated with the player's selected subset of player reels. In act 1008, at least one game outcome is determined for each player from an array of symbols randomly generated from the player's selected subset of player reels. In act 1010, the players are ranked according to the game outcomes for the players. In act 1012, awards are determined for the players according to the ranking of the players. Thus, in the approach 1000, players may draft a combination of player reels from a pool of player reels to compete against each other according to the game outcomes from their respective combinations of player reels.

Although the players in the embodiments described above may contribute complete player reels to a game screen, it is understood that players in other embodiments can contribute portions of a player reel and be spliced with portions of one or more player reels contributed by one or more other players.

It is understood that the modes of gameplay are not limited to the examples described above. For example, rather than employing aspects of fantasy sports, the communal wagering game may employ aspects of board games to encourage interaction between players and further enhance interest in the communal wagering game. For example, in an embodiment inspired by the board game MONOPOLY®, players may be required to collect certain player reels to advance to different levels of gameplay and/or earn awards, where progress by each player is tracked on a common game board.

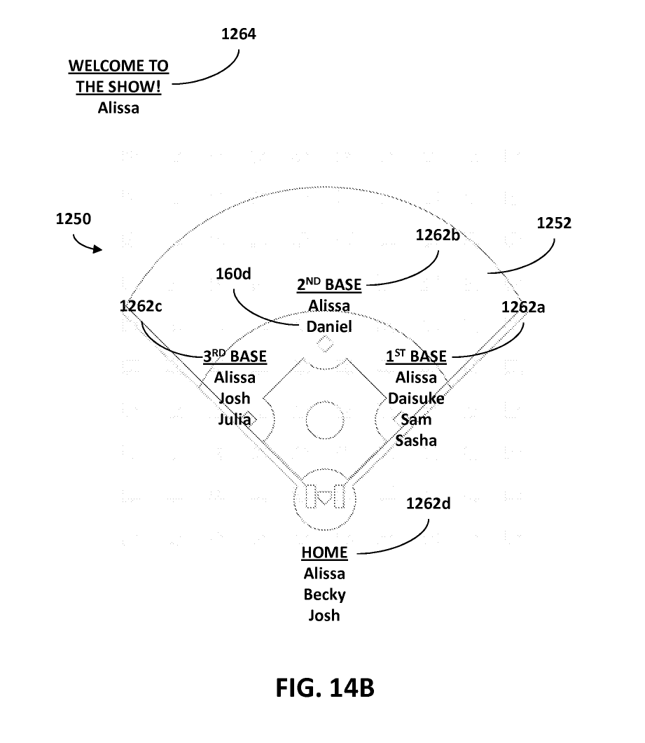

In some embodiments, a player reel may be provided with a special symbol that relates to a secondary game. For example, referring to FIG. 14A, a game screen 1150 is illustrated. The game screen 1150 is similar to the game screen 150 shown in FIG. 4, except the profile 160d is associated with a player reel 1162d. The player reel 1162d includes a special symbol 1162d1. A special symbol may be included in the initial version of the player reel. Alternatively, a player may subsequently obtain the special symbol and add it to an existing player reel (e.g, as a replacement). A special symbol can be obtained, for example, by making some type of payment, exchanging loyalty points from a loyalty program, redeeming bonus awards from prior gameplay, etc. Unlike other symbols on the player reel 1162d, the special symbol 1162d1 relates to a secondary game rather than the game shown on the game screen 1150. In other words, the special symbol 1162d1 may not necessarily improve the outcomes achieved by the game reels 152a-e on the game screen 1150. Instead, by possessing the player reel 1162d with the special symbol 1162d1, the player “Daniel” who is associated with the profile 160d has qualified to participate in a broader secondary game that involves a pool of players that is larger than the five players associated with the game screen 1150. The other players associated with the game screen 1150 may or may not have qualified to play the secondary game depending on whether they too have obtained the necessary special symbol(s). Additionally, the special symbol special symbol 1162d1 may be used in actual gameplay of the secondary game.

A secondary game may require players to collect certain special symbols to advance to different levels of gameplay and/or earn awards, where progress by each player is tracked on a common game board. For example, FIG. 14B illustrates a secondary game screen 1250 that is associated with a secondary game that is inspired by baseball. The game screen 1250 presents a baseball diamond 1252 with positions 1262a-d representing “1ST BASE,” “2ND BASE,” “3RD BASE,” and “HOME,” respectively. In one embodiment, a player becomes eligible for a grand jackpot by collecting special symbols that correspond to each of the positions 1262a-d. As shown in FIG. 14A, the special symbol 1162d1 on the player reel 1162d is a “2ND BASE” symbol. Correspondingly, the profile 160d for the player “Daniel” is shown at the “2ND BASE” position 1262d in the secondary game screen 1250. As FIG. 14B illustrates, the player “Daniel” must still collect special symbols that correspond to the remaining positions 1262a, 1262c, and 1262d. Meanwhile, other players are shown at different combinations of the positions 1262a-d. Those who have collected all four required special symbols (e.g., the player “Alissa”) are shown in a qualifying list 1264. It is noted that the players of the secondary game shown in FIG. 14B make up a pool of players that is larger than the players on the game screen 1150 shown in FIG. 14A. As such, the secondary game encourages further social interaction between different players in the community.

In alternative embodiments, a player may be required to obtain the special symbols in a particular order/progression before qualifying, e.g., a player must move to the “1ST BASE” position 1262a before moving to the “2ND BASE,” and so on. In an example of the alternative embodiments, obtaining another special symbol corresponding to a “HOMERUN” may be equivalent to obtaining the special symbols for “1ST BASE,” “2ND BASE,” “3RD BASE,” and “HOME.”

In some embodiments, to encourage further social interaction between players, a player may be able to combine his/her special symbol(s) with the special symbol(s) of one or more other players to share in an outcome in the secondary game. In general, it is contemplated that communal wagering games may be associated with a secondary game, where certain symbols on the player reels can be earned or otherwise obtained to participate in the secondary game. The secondary game generates additional excitement for players of the communal wagering game.

Each of these embodiments and obvious variations thereof is contemplated as falling within the spirit and scope of the claimed invention, which is set forth in the following claims. Moreover, the present concepts expressly include any and all combinations and subcombinations of the preceeding elements and aspects.

What is claimed is:

1. A gaming system comprising:
one or more input devices;
one or more display devices;
game-logic circuitry, comprising one or more central processing units and one or more memory devices, the one or more memory devices storing instructions that, when executed by the one or more central processing units, cause the game-logic circuitry to:
define at least one first player reel;
associate the at least one first player reel with a first player;
combine the at least one first player reel with one or more second player reels associated with one or more second players, the at least one first player reel and the one or more second player reels each including a respective set of symbols;
determine at least one game outcome from an array of symbols randomly generated from the combination of the at least one first player reel and the one or more second player reels;
display, on at least one of the display devices, a game screen presenting the at least one game outcome; and
determine awards for the first player and the one or more second players based on the at least one game outcome.

2. The gaming system of claim 1, wherein, in response to receiving a request from the first player via at least one of the input devices, the instructions further cause the game-logic circuitry to:
combine the at least one first player reel with one or more third player reels associated with one or more third players, the one or more third player reels each including a respective set of symbols;
determine at least one new game outcome from an array of symbols randomly generated from the combination of the at least one first player reel and the one or more third player reels;
display, on at least one of the display devices, a new game screen presenting the at least one new game outcome; and
determine awards based on the at least one new game outcome.

3. The gaming system of claim 1, wherein, prior to combining the at least one first player reel with the one or more second player reels, the instructions further cause the game-logic circuitry to:
display, on at least one of the display devices, a selection screen presenting the one or more second player reels requiring another player reel to be combined therewith; and
receive from the first player, via at least one of the input devices, a request to combine the at least one first player reel with the one or more second player reels.

4. The gaming system of claim 3, wherein one or more symbols on the one or more second player reels are not visible on the selection screen, and in response to a receiving another request from the first player via at least one of the input devices, the instructions further cause the game-logic circuitry to make the not-visible symbols visible.

5. The gaming system of claim 1, wherein, in response to receiving a request from the first player via at least one of the input devices, the instructions further cause the game-logic circuitry to associate the at least one player reel with a fourth player.

6. The gaming system of claim 1, wherein the instructions further cause the game-logic circuitry to receive a request from the first player to select the at least one player reel from a plurality of available player reels and to associate the at least one first player reel with the first player.

7. The gaming system of claim 1, wherein the player reels in the gaming system have a value based on their respective set of symbols and the instructions further cause the game-logic circuitry to selectively display, on at least one of the displays, the values for the player reels.

8. The gaming system of claim 7, wherein, prior to combining the at least one first player reel with the one or more second player reels, the instructions further cause the game-logic circuitry to verify that the values of the at least one first player reel and the one or more second player reels meet predetermined criteria.

9. The gaming system of claim 1, wherein, after a predetermined number of game outcomes have been determined with the at least one first player reel, the instructions further cause the game-logic circuitry to expire the at least one first player reel and disassociate the at least one first player reel from any player.

10. The gaming system of claim 1, wherein the instructions further cause the game-logic circuitry to place the first player and the one or more second players in competition against one or more competing groups of players, wherein the at least one game outcome from the combination of the at least one first player reel and the one or more second player reels is compared to one or more competing game outcomes associated with the one or more competing groups of players.

11. A computer-implemented method in a gaming system having game-logic circuitry including one or more central processing units and one or more memory devices, the method comprising:
defining at least one first player reel;
associating the at least one first player reel with a first player;
combining the at least one first player reel with one or more second player reels associated with one or more second players, the at least one first player reel and the one or more second player reels each including a respective set of symbols;
determining at least one game outcome from an array of symbols randomly generated from the combination of the at least one first player reel and the one or more second player reels;
displaying a game screen presenting the at least one game outcome;
determining awards based on the at least one game outcome to the first player and the one or more second players; and
displaying the awards on at least one of the display devices.

12. The computer-implemented method of claim 11, further comprising:
receiving a request from the first player via at least one of the input devices;
in response to receiving the request, combining the at least one first player reel with one or more third player reels associated with one or more third players, the one or more third player reels each including a respective set of symbols;
determining at least one new game outcome from an array of symbols randomly generated from the combination of the at least one first player reel and the one or more third player reels;
displaying, on at least one of the display devices, a new game screen presenting the at least one new game outcome;
determining awards based on the at least one new game outcome to the first player and the one or more third players; and
displaying the awards on at least one of the display devices.

13. The computer-implemented method of claim 11, further comprising, prior to combining the at least one first player reel with the one or more second player reels:
displaying, on at least one of the display devices, a selection screen presenting the one or more second player reels requiring another player reel to be combined therewith; and
receiving from the first player, via at least one of the input devices, a request to combine the at least one first player reel with the one or more second player reels.

14. The computer-implemented method of claim 13, wherein one or more symbols on the one or more second player reels are not visible on the selection screen, and in response to a receiving another request from the first player via at least one of the input devices, the instructions further cause the game-logic circuitry to make the not-visible symbols visible.

15. The computer-implemented method of claim 11, further comprising:
receiving a request from the first player via at least one of the input devices; and
in response to receiving the request, associating the at least one player reel to a fourth player.

16. The computer-implemented method of claim 11, further comprising:
receiving a request from the first player to select the at least one player reel from a plurality of available player reels; and
associating the at least one first player reel with the first player.

17. The computer-implemented method of claim 11, wherein the player reels in the gaming system have a value based on their respective set of symbols and the method further comprises selectively displaying, on at least one of the displays, the values for the player reels.

18. The computer-implemented method of claim 11, further comprising, prior to combining the at least one first player reel with the one or more second player reels, verifying that the values of the at least one first player reel and the one or more second player reels meet predetermined criteria.

19. The computer-implemented method of claim 11, further comprising, after a predetermined number of game outcomes has been determined with the at least one first player reel, expiring the at least one first player reel and disassociating the at least one first player reel from any player.

20. The computer-implemented method of claim 11, further comprising placing the first player and the one or more second players in competition against one or more competing groups of players, wherein the at least one game outcome from the combination of the at least one first player reel and the one or more second player reels is compared to one or more competing game outcomes associated with the one or more competing groups of players.

21. A gaming system comprising:
one or more input devices;
one or more display devices;
game-logic circuitry, comprising one or more central processing units and one or more memory devices, the one or more memory devices storing instructions that, when executed by the one or more central processing units, cause the game-logic circuitry to:
define a plurality of player reels, each player reel including a respective set of symbols;
receive from each of a plurality of players, via at least one of the input devices, a respective selection of a subset of the player reels;
associate each of the plurality of players with the player's respective subset of player reels;
determine at least one game outcome for each of the plurality of players, the at least one game outcome being determined from an array of symbols randomly generated from the player's respective subset of player reels;
display, on at least one of the display devices, the at least one game outcome for each of the plurality of players;
rank the players according to the game outcomes for the plurality of players; and
provide awards to the players according to the ranking of the players.

22. The gaming system of claim 21, wherein the player reels in the gaming system have a value based on their respective set of symbols and the instructions further cause the game-logic circuitry to selectively display, on at least one of the displays, the values for the player reels.

23. The gaming system of claim 22, wherein the instructions further cause the game-logic circuitry to restrict the selections of subsets of the player reels according to the values of the player reels.

24. A computer-implemented method in a gaming system having game-logic circuitry including one or more central processing units and one or more memory devices, the method comprising:
defining a plurality of player reels, each player reel including a respective set of symbols;
receiving from each of a plurality of players, via at least one of the input devices, a respective selection of a subset of the player reels;
associating each of the plurality of players with the player's respective subset of player reels;
determining at least one game outcome for each of the plurality of players, the at least one game outcome being determined from an array of symbols randomly generated from the player's respective subset of player reels;
displaying, on at least one of the display devices, the at least one game outcome for each of the plurality of players;
ranking the players according to the game outcomes for the plurality of players; and
providing awards to the players according to the ranking of the players.

25. The computer-implemented method of claim 24, wherein the player reels in the gaming system have a value based on their respective set of symbols and the method further comprises selectively displaying, on at least one of the displays, the values for the player reels.

26. The computer-implemented method of claim 25, further comprising restricting the selections of subsets of the player reels according to the values of the player reels.
